(19) United States
(12) Patent Application Publication
(10) Pub. No.: US 2020/0227963 A1
(43) Pub. Date: Jul. 16, 2020

(54) ROTOR CORE OF ROTATING ELECTRICAL MACHINE

(71) Applicant: HONDA MOTOR CO., LTD., Tokyo (JP)

(72) Inventor: Manabu YATSURUGI, Saitama (JP)

(73) Assignee: HONDA MOTOR CO., LTD., Tokyo (JP)

(21) Appl. No.: 16/740,669

(22) Filed: Jan. 13, 2020

(30) Foreign Application Priority Data
Jan. 15, 2019 (JP) 2019-004443

(51) Int. Cl. H02K 1/30; H02K 1/27

(52) U.S. Cl. CPC H02K 1/30; H02K 29/03; H02K 1/276

(57) ABSTRACT

A rotor core of a rotating electrical machine includes: a rotor shaft hole in which a rotor shaft is tightened; a shaft holding portion; an electromagnetic portion; and a plurality of ribs connecting the shaft holding portion and the electromagnetic portion. A rib of the plurality of ribs includes: a first end surface and a second end surface forming both circumferential end surfaces; and a lightening hole provided between the first end surface and the second end surface. The first end surface and the second end surface of the rib include: inner end portions; outer end portions; concave curved portions extending from the outer end portion to a radial inner side in a curved manner; and convex curved portions which are continuous with the concave curved portions, are curved so as to protrude outward from the rib in the circumferential direction, and extend radially inward.

### CROSS-REFERENCE TO RELATED APPLICATIONS

The present application claims the benefit of priority of Japanese Patent Application No. 2019-004443, filed on Jan. 15, 2019, the content of which is incorporated herein by reference.

### TECHNICAL FIELD

The present invention relates to a rotor core constituting a rotor of a rotating electrical machine.

### BACKGROUND ART

In recent years, as a rotor used in rotating electrical machines, a rotor having a substantially annular rotor core with a rotor shaft tightened on an inner peripheral surface and a plurality of permanent magnets arranged at predetermined intervals in a circumferential direction on an outer peripheral portion of the rotor core is known.

The rotor core of this type of rotating electrical machine has a risk that an outer peripheral surface of the rotor core is deformed radially outward due to a tightening load of the rotor shaft and the output performance of the rotating electrical machine is reduced. Further, due to a centrifugal force generated in the rotor core and permanent magnet due to the rotation of the rotor of the rotating electrical machine, an inner peripheral surface of the rotor core may be deformed radially outward and the tightening margin of the rotor shaft may be reduced.

Therefore, as a technology to suppress the outer radial deformation of the outer circumferential surface of the rotor core due to a tightening load of the rotor shaft and the outer radial deformation of the inner circumference surface of the rotor core due to the centrifugal force generated in the rotor core and permanent magnet, for example, JP-A-2014-158331 is disclosed.

JP-A-2014-158331 discloses a rotor core of a rotating electrical machine which includes a plurality of inner circumferential ribs arranged at predetermined intervals in a circumferential direction and suppressing a tightening load of the rotor shaft from being transmitted to an electromagnetic portion on an outer circumferential side of the rotor core and a plurality of outer circumferential side ribs arranged at predetermined intervals in the circumferential direction and preventing a centrifugal force generated in a rotor core and a permanent magnet from being transmitted to a shaft holding portion on an inner circumferential side of the rotor core.

However, since the rotor core of the rotating electrical machine of JP-A-2014-158331 includes the inner circumferential side ribs and the outer circumferential side ribs, two ribs have to be arranged in a radial direction. Therefore, it is difficult to reduce the size of the rotor core and it is difficult to increase the diameter of the inner circumferential surface of the rotor core.

### SUMMARY

The invention provides a rotor core of a rotating electrical machine in which, without disposing two ribs in a radial direction, it is possible to suppress compressive stress due to a tightening load of a rotor shaft from being transmitted to an electromagnetic portion while suppressing the transmission of tensile stress due to centrifugal force to a shaft holding portion.

According to an aspect of the invention, there is provided a rotor core of a rotating electrical machine including: a rotor shaft hole in which a rotor shaft is tightened; a shaft holding portion provided on a radial outer side of the rotor shaft hole and having a substantially annular shape; an electromagnetic portion provided on a radial outer side of the shaft holding portion, having a substantially annular shape, and having a plurality of magnet insertion holes into which permanent magnets are respectively inserted; and a plurality of ribs connecting the shaft holding portion and the electromagnetic portion, wherein: a rib of the plurality of ribs includes: a first end surface and a second end surface forming both circumferential end surfaces extending from the electromagnetic portion to the shaft holding portion and having a circumferentially symmetric shape with an imaginary straight line connecting a circumferential central portion of the rib and a center of the rotor core as an axis; and a lightening hole provided between the first end surface and the second end surface of the rib and having a bottom portion formed along an outer circumferential edge of the shaft holding portion, a top portion formed further on a radial outer side than the bottom portion, and a first side wall portion on the first end surface side and a second side wall portion on the second end surface side which extend from the bottom portion to the top portion and are symmetrically formed in a circumferential direction about the imaginary straight line; the first end surface and the second end surface of the rib include: inner end portions connected to the shaft holding portion; outer end portions connected to the electromagnetic portion; concave curved portions extending from the outer end portion to a radial inner side in a curved manner so as to protrude toward a central side of the rib in a circumferential direction; and convex curved portions which are continuous with the concave curved portions, are curved so as to protrude outward from the rib in the circumferential direction, and extend radially inward so as to be away from the imaginary straight line; and the concave curved portions are formed with recesses in which a circumferential distance between the first end surface and the second end surface is the shortest.

### Effects

According to the invention, the tensile stress caused by the centrifugal force and the compressive stress caused by the tightening load of the rotor shaft can be offset in parts of the concave curved portions of the first end surface and the second end surface of the rib, which are areas located further on the radial inner side than the recesses, and the first side wall portion and the second side wall portion of the lightening portion. Therefore, without arranging two ribs in the radial direction, it is possible to suppress the transmission of the compressive stress due to the tightening load of the rotor shaft to the electromagnetic portion while suppressing the tensile stress due to the centrifugal force from being transmitted to the shaft holding portion.

### BRIEF DESCRIPTION OF THE DRAWINGS

FIG. 1 is a front view of a rotor core according to a first embodiment of the invention;

FIG. 2 is an enlarged view of a rib of the rotor core according to the first embodiment of the invention; and

FIG. 3 is an enlarged view of a rib of a rotor core according to a second embodiment of the invention.

### DESCRIPTION OF EMBODIMENTS

Hereinafter, each embodiment of a rotor core of a rotating electrical machine of the invention will be described with reference to the accompanying drawings.

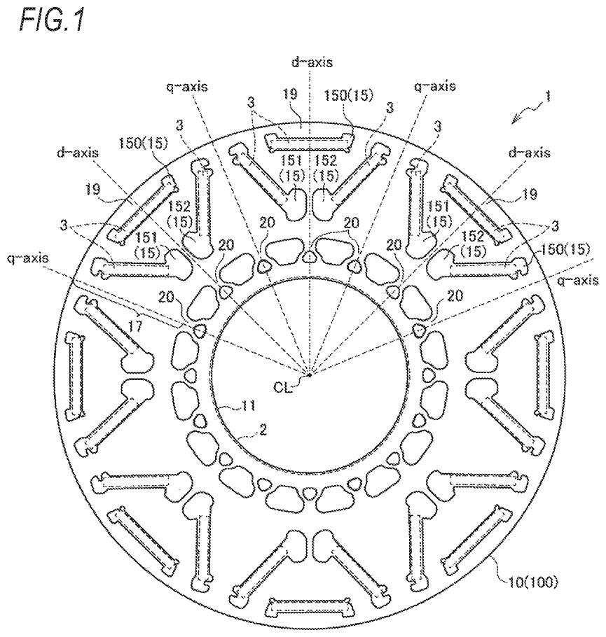

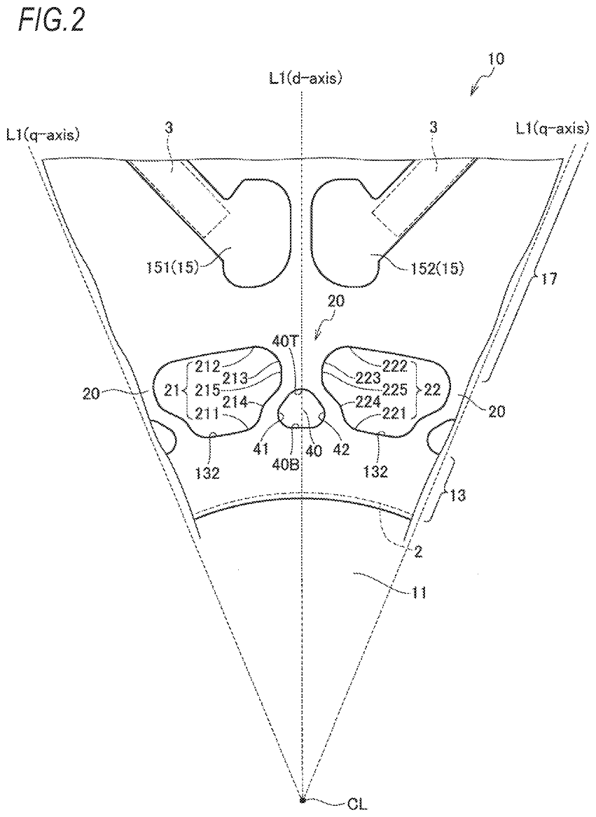

First, a rotor core according to a first embodiment of the invention will be described with reference to FIGS. 1 and 2.

A rotor core 10 is configured by laminating a plurality of electromagnetic steel plates 100 in an axial direction of a rotor shaft 2 and constitutes a rotor 1 of a motor together with the rotor shaft 2 and a plurality of permanent magnets 3 assembled to the rotor core 10. The permanent magnet 3 is, for example, a neodymium magnet.

As illustrated in FIG. 1, the rotor core 10 has an annular shape in which a rotor shaft hole 11 in which the rotor shaft 2 is tightened is provided at a center CL. The rotor core 10 includes a shaft holding portion 13 provided on a radially outer side of the rotor shaft hole 11 and having a substantially annular shape, an electromagnetic portion 17 provided on the radially outer side of the shaft holding portion 13, having a substantially annular shape, and having a plurality of magnet insertion holes 15 into which the permanent magnets 3 are respectively inserted, and a plurality of ribs 20 connecting the shaft holding portion 13 and the electromagnetic portion 17.

The electromagnetic portion 17 is disposed on an outer peripheral portion of the rotor core 10 and faces a stator (not illustrated). In the electromagnetic portion 17, a plurality of magnetic pole portions 19 (eight in this embodiment) are formed at equal intervals along a circumferential direction. In the embodiment, one magnetic pole portion 19 is constituted by three permanent magnets 3 inserted into an outer diameter side magnet insertion hole 150 disposed on the outer peripheral side of the rotor core 10 so as to be substantially perpendicular to a radial direction and a pair of an inner diameter side first magnet insertion hole 151 and an inner diameter side second magnet insertion hole 152 arranged so as to form a substantially isosceles triangle convex toward the center CL side with the outer diameter side magnet insertion hole 150 as the base.

A plurality of ribs 20 connect the shaft holding portion 13 and the electromagnetic portion 17 and are provided along the circumferential direction. In the embodiment, when a center axis of each magnetic pole portion 19 connecting the center CL and the center of each magnetic pole portion 19 is set to a d axis (d axis in the drawing) and an axis which is 90 electrical degrees apart from the d axis is set to a q axis (q axis in the drawing), the ribs 20 are provided on the d-axis and the q-axis along the circumferential direction.

As illustrated in FIG. 2, the rib 20 includes a first end surface 21 and a second end surface 22 which extend in the radial direction from the electromagnetic portion 17 to the shaft holding portion 13 and form both circumferential end surfaces. The first end surface 21 and the second end surface 22 have a symmetrical shape in the circumferential direction about an imaginary straight line L1 which connects the central portion in the circumferential direction of the rib 20 and the center CL. In the embodiment, the imaginary straight line L1 coincides with the d axis or the q axis.

The first end surface 21 and the second end surface 22 have inner end portions 211 and 221 connected to an outer circumferential edge 132 of the shaft holding portion 13 and outer end portions 212 and 222 connected to an inner circumferential edge 171 of the electromagnetic portion 17. The first end surface 21 and the second end surface 22 include concave curved portions 213 and 223 extending radially inward from the outer end portions 212 and 222 in a curved manner so as to protrude toward the center side of the rib 20 in the circumferential direction and convex curved portions 214 and 224 which are continuous with the concave curved portions 213 and 223, are curved to protrude outward of the rib 20 in the circumferential direction, and extend radially inward so as to be away from the imaginary straight line L1. The concave curved portions 213 and 223 of the first end surface 21 and the second end surface 22 are formed with recesses 215 and 225 in which the circumferential distance between the first end surface 21 and the second end surface 22 is the shortest.

Between the first end surface 21 and the second end surface 22 of the rib 20, a lightening hole 40 is provided. The lightening hole 40 has a bottom portion 40B and a top portion 40T formed further on the outer side in the radial direction than the bottom portion 40B. The bottom portion 40B is formed along the outer circumferential edge 132 of the shaft holding portion 13 and has a predetermined length in the circumferential direction. The top portion 40T is formed further on the radially inner side than the recesses 215 and 225 of the first end surface 21 and the second end surface 22 of the rib 20.

The lightening hole 40 includes a first side wall portion 41 on the first end surface 21 side of the rib 20 and a second side wall portion 42 on the second end surface 22 side of the rib 20 which extend from the bottom portion 40B to the top portion 40T and are symmetrically formed in the circumferential direction about the imaginary straight line L1. Each of the first side wall portion 41 and the second side wall portion 42 of the lightening hole 40 has a curved shape extending from the bottom portion 40B to the top portion 40T in a curved manner so as to protrude outside the lightening hole 40 in the circumferential direction.

When the rotor shaft 2 is fastened to the rotor shaft hole 11 in the rotor core 10, the shaft holding portion 13 receives a tightening load in a radially outward direction. This tightening load acting on the shaft holding portion 13 causes a compressive stress on the rib 20. In this case, due to the shape of rib 20, the tensile stress generated in the rib 20 is concentrated in the concave curved portions 213 and 223 of the first end surface 21 and the second end surface 22 which are located further on the radial outer side than the recesses 215 and 225 and the first side wall portion 41 and the second side wall portion 42 of the lightening hole 40.

When the rotating electrical machine is driven and the rotor 1 rotates, the electromagnetic portion 17 receives a centrifugal load due to the centrifugal force generated in the rotor core 10 and the permanent magnet 3 inserted into a magnet insertion hole 15 of the electromagnetic portion 17 of the rotor core 10. This centrifugal load acting on the electromagnetic portion 17 generates a tensile stress on the rib 20. In this case, due to the shape of the rib 20, the tensile stress generated in the rib 20 is concentrated in the concave curved portions 213 and 223 of the first end surface 21 and the second end surface 22 which are located further on the radial inner side than the recesses 215 and 225 and the first side wall portion 41 and the second side wall portion 42 of the lightening hole 40.

Therefore, both the compressive stress generated in the rib 20 due to the tightening load of the rotor shaft 2 and the tensile stress generated in the rib 20 due to the centrifugal force generated in the rotor core 10 and the permanent magnet 3 are concentrated in parts of the concave curved portions 213 and 223 of the first end surface 21 and the second end surface 22 of the rib 20, which are areas located further on the radial inner side than the recesses 215 and 225, and the first side wall portion 41 and the second side wall portion 42 of the lightening hole 40. Thus, in the rib 20, the compressive stress and the tensile stress generated in rib 20 are offset in parts of the concave curved portions 213 and 223 of the first end surface 21 and the second end surface 22, which are the areas located further on the radial inner side than the recesses 215 and 225, and the first side wall portion 41 and the second side wall portion 42 of the lightening hole 40. As a result, without arranging two ribs in the radial direction, the rotor core 10 can suppress the tensile stress due to the centrifugal force from being transmitted to the shaft holding portion 13 and suppress the compressive stress due to the tightening load of the rotor shaft 2 from being transmitted to the electromagnetic portion 17. Furthermore, since the rotor core 10 does not need to arrange two ribs in the radial direction, the diameter of the rotor core 10 can be reduced. In addition, by increasing the diameter of the inner peripheral surface of the rotor core 10, a power transmission mechanism or the like can be provided between the rotor shaft 2 and the rotor core 10.

Further, since the top portion 40T of the lightening hole 40 is disposed further on a radial inner side than the recesses 215 and 225 of the concave curved portions 213 and 223 of the first end surface 21 and the second end surface 22 of the rib 20 and the first side wall portion 41 and the second side wall portion 42 of the lightening hole 40 have a curved shape extending from the bottom portion 40B to the top portion 40T in a curved manner so as to protrude outward from the lightening hole 40 in the circumferential direction, the lightening hole 40 can be a simple shape. As a result, the formation of the lightening hole 40 is facilitated and the durability of the rotor core 10 is improved.

Furthermore, since the rib 20 has a shape in which the first end surface 21 and the second end surface 22 and the first side wall portion 41 and the second side wall portion 42 of the lightening hole 40 are symmetrical in the circumferential direction about the imaginary straight line L1, the rib 20 can receive the tensile stress caused by the centrifugal force and the compressive stress caused by the tightening load of the rotor shaft 2 evenly in the circumferential direction. Thereby, it can prevent that the outer peripheral surface of the rotor core 10 deforms unevenly and the increase in the torque ripple resulting from the deformation of the outer peripheral surface of the rotor core 10 can be suppressed.

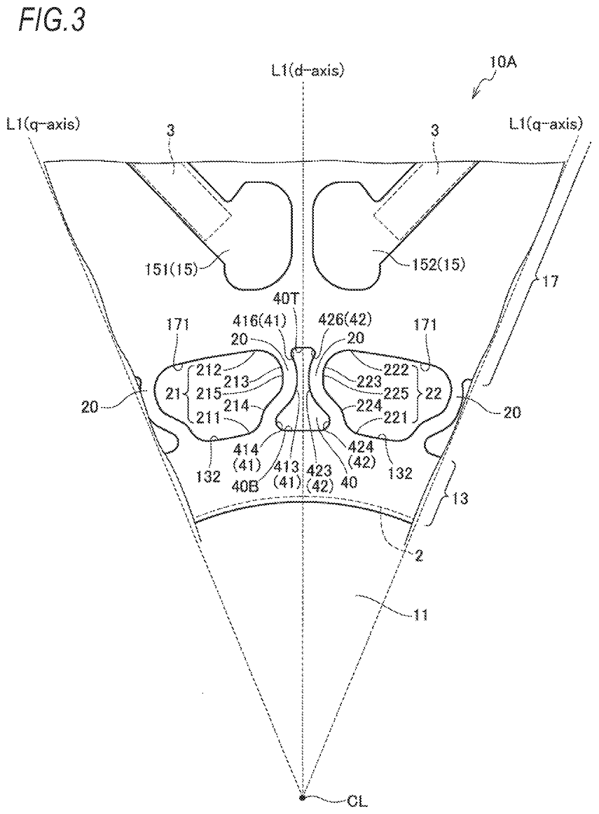

Next, a rotor core 10A according to a second embodiment of the invention will be described with reference to FIG. 3. In the following description, the same components as those of the rotor core 10 of the first embodiment are denoted by the same reference numerals and description thereof is omitted or simplified. The shape of the lightening hole 40 is different between the rotor core 10 of the first embodiment and the rotor core 10A of the second embodiment. Hereinafter, differences between the rotor core 10 of the first embodiment and the rotor core 10A of the second embodiment will be described in detail.

As illustrated in FIG. 3, the first end surface 21 and the second end surface 22 forming both circumferential end surfaces of the rib 20 of the second embodiment have the same shape as the first end surface 21 and the second end surface 22 of the first embodiment.

The lightening hole 40 of the second embodiment has a bottom portion 40B and a top portion 40T formed further on a radial outer side than the bottom portion 40B. The bottom portion 40B is formed along the outer circumferential edge 132 of the shaft holding portion 13 and has a predetermined length in the circumferential direction. The top portion 40T is formed along the inner circumferential edge 171 of the electromagnetic portion 17 and has a predetermined length in the circumferential direction.

The lightening hole 40 has the first side wall portion 41 on the first end surface 21 side of the rib 20 and the second side wall portion 42 on the second end surface 22 side of the rib 20 which extend from the bottom portion 40B to the top portion 40T and are formed symmetrically in the circumferential direction about the imaginary straight line L1.

The first side wall portion 41 and the second side wall portion 42 of the lightening hole 40 include inner diameter side convex curved portions 414 and 424 which extend from the bottom portion 40B to a radial outer side in a curved manner so as to protrude outwardly from the lightening hole 40 in the circumferential direction, outer diameter side convex curved portions 416 and 426 which extend from the top portion 40T to a radial inner side in a curved manner so as to protrude outwardly from the lightening hole 40 in the circumferential direction, and concave curved portions 413 and 423 which connect the inner diameter side convex curved portions 414 and 424 and the outer diameter side convex curved portions 416 and 426 and extend in a curved manner so as to protrude inside the lightening hole 40 in the circumferential direction.

The first side wall portion 41 and the second side wall portion 42 of the lightening hole 40 extend in the radial direction in parallel with the first end surface 21 and the second end surface 22 of the rib 20. That is, the circumferential width between the first side wall portion 41 of the lightening hole 40 and the first end surface 21 of the rib 20 is substantially uniform and the circumferential width between the second side wall portion 42 of the lightening hole 40 and the second end surface 22 of the rib 20 is substantially uniform.

When the rotor shaft 2 is fastened to the rotor shaft hole 11 in the rotor core 10A, the shaft holding portion 13 receives a tightening load in the radially outward direction. This tightening load acting on the shaft holding portion 13 causes a compressive stress on the rib 20. In this case, due to the shape of the rib 20, the tensile stresses generated in the rib 20 is concentrated in the concave curved portions 213 and 223 of the first end surface 21 and the second end surface 22 which are located further on the radial inner side than the recesses 215 and 225 and the inner diameter side convex curved portions 414 and 424 and the outer diameter side convex curved portions 416 and 426 of the first side wall portion 41 and the second side wall portion 42 of the lightening hole 40.

When the rotating electrical machine is driven and the rotor 1 rotates, the electromagnetic portion 17 receives a centrifugal load by the centrifugal force generated in the rotor core 10A and the permanent magnet 3 inserted in the magnet insertion hole 15 of the electromagnetic portion 17 of the rotor core 10A. This centrifugal load acting on the electromagnetic portion 17 generates a tensile stress on the rib 20. In this case, due to the shape of the rib 20, the tensile stress generated in the rib 20 is concentrated in the concave curved portions 213 and 223 of the first end surface 21 and the second end surface 22 which are located further on the radial inner side than the recesses 215 and 225 and the inner diameter side convex curved portions 414 and 424 and the outer diameter side convex curved portions 416 and 426 of the first side wall portion 41 and the second side wall portion 42 of the lightening hole 40.

Therefore, both the compressive stress generated in the rib 20 due to the tightening load of the rotor shaft 2 and the tensile stress generated in the rib 20 due to the centrifugal force generated in the rotor core 10A and the permanent magnet 3 are concentrated in parts of the concave curved portions 213 and 223 of the first end surface 21 and the second end surface 22 of the rib 20, which are areas located further on the radial inner side than the recesses 215 and 225 and the inner diameter side convex curved portions 414 and 424 and the outer diameter side convex curved portions 416 and 426 of the first side wall portion 41 and the second side wall portion 42 of the lightening hole 40. As a result, in the rib 20, the compressive stress and the tensile stress generated in the rib 20 are offset in parts of the concave curved portions 213 and 223 of the first end surface 21 and the second end surface 22, which are the areas located further on the radial inner side than the recesses 215 and 225 and the inner diameter side convex curved portions 414 and 424 and the outer diameter side convex curved portions 416 and 426 of the first side wall portion 41 and the second side wall portion 42 of the lightening hole 40. Thus, without arranging two ribs in the radial direction, the rotor core 10A can suppress the tensile stress due to the centrifugal force from being transmitted to the shaft holding portion 13 and suppress the compressive stress due to the tightening load of the rotor shaft 2 from being transmitted to the electromagnetic portion 17.

Further, since the top portion 40T of the lightening hole 40 is formed along an inner circumferential edge 171 of the electromagnetic portion 17, the lightening hole 40 has a shape extending from the outer circumferential edge 132 of the shaft holding portion 13 to an inner circumferential edge 171 of the electromagnetic portion 17. As a result, the size of the lightening hole 40 can be increased, and thus the rotor core 10A can be reduced in weight.

In addition, this invention is not limited to the embodiments described above and can be appropriately modified, improved, and the like.

For example, in the first embodiment and the second embodiment, one magnetic pole portion 19 is constituted by three permanent magnets 3 inserted into the outer diameter side magnet insertion hole 150 disposed on the outer peripheral side of the rotor core 10 or 10A so as to be substantially perpendicular to the radial direction and a pair of the inner diameter side first magnet insertion hole 151 and the inner diameter side second magnet insertion hole 152 arranged so as to form a substantially isosceles triangle convex toward the center CL side with the outer diameter side magnet insertion hole 150 as the base. However, the pair of the inner diameter side first magnet insertion hole 151 and the inner diameter side second magnet insertion hole 152 may be omitted and one magnetic pole portion 19 may be constituted only by the permanent magnet 3 inserted into the outer diameter side magnet insertion hole 150. On the other hand, the outer diameter side magnet insertion hole 150 may be omitted and one magnetic pole portion 19 may be constituted by the permanent magnets 3 inserted into the pair of the inner diameter side first magnet insertion hole 151 and the inner diameter side second magnet insertion hole 152.

Further, for example, in the first embodiment and the second embodiment, the permanent magnet 3 is a flat plate magnet, but may be a circular arc magnet convex inward in the radial direction.

Further, for example, in the first embodiment and the second embodiment, the ribs 20 are assumed to be provided on the d axis and the q axis along the circumferential direction. However, the ribs 20 may be provided at positions different from the d axis or the q axis in the circumferential direction.

In addition, at least the following matters are described in this specification. Although the components or the likes which correspond to those in the embodiments described above are shown in a parenthesis, it is not limited to this.

(1) A rotor core (rotor core 10, 10A) of a rotating electrical machine which includes a rotor shaft hole (rotor shaft hole 11) in which a rotor shaft (rotor shaft 2) is tightened, a shaft holding portion (shaft holding portion 13) provided on a radial outer side of the rotor shaft hole and having a substantially annular shape, an electromagnetic portion (electromagnetic portion 17) provided on a radial outer side of the shaft holding portion, having a substantially annular shape, and having a plurality of magnet insertion holes (magnet insertion holes 15) into which permanent magnets (permanent magnets 3) are respectively inserted, and a plurality of ribs (ribs 20) connecting the shaft holding portion and the electromagnetic portion, in which

the rib includes,

a first end surface (first end surface 21) and a second end surface (second end surface 22) forming both circumferential end surfaces extending from the electromagnetic portion to the shaft holding portion and having a circumferentially symmetric shape with an imaginary straight line (imaginary straight line L1) connecting a circumferential central portion of the rib and a center (center CL) of the rotor core as an axis, and

a lightening hole (lightening hole 40) provided between the first end surface and the second end surface of the rib and having a bottom portion (bottom portion 40B) formed along an outer circumferential edge (outer circumferential edge 132) of the shaft holding portion, a top portion (top portion 40T) formed further on a radial outer side than the bottom portion, and a first side wall portion (first side wall portion 41) on the first end surface side and a second side wall portion (second side wall portion 42) on the second end surface side which extend from the bottom portion to the top portion and are symmetrically formed in a circumferential direction about the imaginary straight line,

the first end surface and the second end surface of the rib include,

inner end portions (inner end portions 211, 221) connected to the shaft holding portion,

outer end portions (outer end portions 212, 222) connected to the electromagnetic portion,

concave curved portions (concave curved portions 213, 223) extending from the outer end portion to a radial inner side in a curved manner so as to protrude toward a central side of the rib in a circumferential direction, and

convex curved portions (convex curved portions 214, 224) which are continuous with the concave curved portions, are curved so as to protrude outward from the rib in the circumferential direction, and extend radially inward so as to be away from the imaginary straight line, and

the concave curved portions are formed with recesses (recesses 215, 225) in which a circumferential distance between the first end surface and the second end surface is the shortest.

According to (1), the first end surface and the second end surface of the rib include the concave curved portions extending from the outer end portion to the radial inner side in a curved manner so as to protrude toward the central side of the rib in the circumferential direction and the convex curved portions which are continuous with the concave curved portions, are curved so as to protrude outward from the rib in the circumferential direction, and extend radially inward so as to be away from the imaginary straight line. In addition, the concave curved portions are formed with recesses in which the circumferential distance between the first end surface and the second end surface is the shortest. Therefore, both the tensile stress generated in the rib due to the centrifugal force generated by the rotation of the rotor core and the compressive stress generated in the rib due to the tightening load acting on the shaft holding portion when the rotor shaft is tightened into the rotor shaft hole are concentrated in parts of the concave curved portions of the first end surface and the second end surface of the rib, which are the areas located further on the radial inner side than the recesses, and the first side wall portion and the second side wall portion of the lightening hole. Therefore, the tensile stress caused by the centrifugal force and the compressive stress caused by the tightening load of the rotor shaft are offset in the parts of the concave curved portions of the first end surface and the second end surface of the rib, which are the areas located further on the radial inner side than the recesses, and the first side wall portion and the second side wall portion of the lightening hole. Thus, without arranging two ribs in the radial direction, the rotor core can suppress the tensile stress due to the centrifugal force from being transmitted to the shaft holding portion and suppress the compressive stress due to the tightening load of the rotor shaft from being transmitted to the electromagnetic portion.

In addition, since, in the rib, the first end surface and the second end surface forming both circumferential end surfaces have a circumferentially symmetric shape with the imaginary straight line connecting the circumferential central portion of the rib and the center of the rotor core as the axis, the rib can receive the tensile stress caused by the centrifugal force and the compressive stress caused by the tightening load of the rotor shaft evenly in the circumferential direction. As a result, the outer circumferential surface of the rotor core can be prevented from being deformed unevenly and an increase in torque ripple due to the deformation of the outer circumferential surface of the rotor core can be suppressed.

(2) The rotor core of the rotating electrical machine according to (1), in which

the top portion of the lightening hole is disposed further on a radial inner side than the recess, and

the first side wall portion and the second side wall portion of the lightening hole have,

a curved shape extending from the bottom portion to the top portion in a curved manner so as to protrude outward from the lightening hole in the circumferential direction.

According to (2), the top portion of the lightening hole is disposed further on the radial inner side than the recesses of the concave curved portions of the first end surface and the second end surface of the rib and the first side wall portion and the second side wall portion of the lightening hole have a curved shape extending from the bottom portion to the top portion in a curved manner so as to protrude outward from the lightening hole in the circumferential direction. Therefore, the lightening hole can be made into a simple shape. As a result, the lightening hole can be easily formed and the durability of the rotor core is improved.

(3) The rotor core of the rotating electrical machine according to (1), in which

the top portion of the lightening hole is formed along an inner circumferential edge (inner circumferential edge 171) of the electromagnetic portion, and

the first side wall portion and the second side wall portion of the lightening hole include,

inner diameter side convex curved portions (inner diameter side convex curved portions 414, 424) extending from the bottom portion to a radial outer side in a curved manner so as to protrude outward from the lightening hole in the circumferential direction,

outer diameter side convex curved portions (outer diameter side convex curved portions 416, 426) extending from the top portion to a radial inner side in a curved manner so as to protrude outward from the lightening hole in the circumferential direction, and

concave curved portions (concave curved portions 413, 423) connecting the inner diameter side convex curved portions and the outer diameter side convex curved portions and extending in a curved manner so as to protrude inside the lightening hole in the circumferential direction.

According to (3), the lightening hole has a shape extending from the outer circumferential edge of the shaft holding portion to the inner circumferential edge of the electromagnetic portion. Therefore, the size of the lightening hole can be increased, and thus the rotor core can be reduced in weight.

1. A rotor core of a rotating electrical machine comprising:
a rotor shaft hole in which a rotor shaft is tightened;
a shaft holding portion provided on a radial outer side of the rotor shaft hole and having a substantially annular shape;
an electromagnetic portion provided on a radial outer side of the shaft holding portion, having a substantially annular shape, and having a plurality of magnet insertion holes into which permanent magnets are respectively inserted; and
a plurality of ribs connecting the shaft holding portion and the electromagnetic portion, wherein:
a rib of the plurality of ribs includes:
a first end surface and a second end surface forming both circumferential end surfaces extending from the electromagnetic portion to the shaft holding portion and having a circumferentially symmetric shape with an imaginary straight line connecting a circumferential central portion of the rib and a center of the rotor core as an axis; and
a lightening hole provided between the first end surface and the second end surface of the rib and having a bottom portion formed along an outer circumferential edge of the shaft holding portion, a top portion formed further on a radial outer side than the bottom portion, and a first side wall portion on the first end surface side and a second side wall portion on the second end surface side which extend from the bottom portion to the top portion and are symmetrically formed in a circumferential direction about the imaginary straight line;
the first end surface and the second end surface of the rib include:
inner end portions connected to the shaft holding portion;
outer end portions connected to the electromagnetic portion;
concave curved portions extending from the outer end portion to a radial inner side in a curved manner so as to protrude toward a central side of the rib in a circumferential direction; and
convex curved portions which are continuous with the concave curved portions, are curved so as to protrude outward from the rib in the circumferential direction, and extend radially inward so as to be away from the imaginary straight line; and
the concave curved portions are formed with recesses in which a circumferential distance between the first end surface and the second end surface is the shortest.

2. The rotor core of the rotating electrical machine according to claim 1, wherein:
the top portion of the lightening hole is disposed further on a radial inner side than the recess; and
the first side wall portion and the second side wall portion of the lightening hole have a curved shape extending from the bottom portion to the top portion in a curved manner so as to protrude outward from the lightening hole in the circumferential direction.

3. The rotor core of the rotating electrical machine according to claim 1, wherein:
the top portion of the lightening hole is formed along an inner circumferential edge of the electromagnetic portion; and
the first side wall portion and the second side wall portion of the lightening hole include:
inner diameter side convex curved portions extending from the bottom portion to a radial outer side in a curved manner so as to protrude outward from the lightening hole in the circumferential direction;
outer diameter side convex curved portions extending from the top portion to a radial inner side in a curved manner so as to protrude outward from the lightening hole in the circumferential direction; and
concave curved portions connecting the inner diameter side convex curved portions and the outer diameter side convex curved portions and extending in a curved manner so as to protrude inside the lightening hole in the circumferential direction.
